(19) United States
(12) Patent Application Publication
(10) Pub. No.: US 2006/0096628 A1
(43) Pub. Date: May 11, 2006

(54) Crutch

(76) Inventor: Il Han, Yongin-si, Gyeonggi-do (KR)

Correspondence Address: STEIN, MCEWEN & BUI, LLP, 1400 EYE STREET, NW, SUITE 300, WASHINGTON, DC, 20005, US

(21) Appl. No.: 10/536,910

(22) PCT Filed: Nov. 26, 2003
(86) PCT No.: PCT/KR03/02570

§ 371 Date: Sep. 12, 2005

(30) Foreign Application Priority Data
Nov. 27, 2002 (KR) 10-2002-0074317

(51) Int. Cl. A61H 3/02

(52) U.S. Cl. 135/71

(57) ABSTRACT

A crutch, which does not give pressure on the tissues, muscles and nerves of the user's armpit, and provides a stabilized walking to a user, is disclosed. The crutch includes a support rod, a cross-pad coupled to an upper end of the support rod, a hand piece provided at a mid point of the support rode, and a cap for preventing the crutch from skidding mounted on a lower end of the support rod. An upper part corresponding to a section between the cross-pad and a predetermined point below the hand piece of the support rod is curved to have a smaller radius, while a lower part corresponding to a section between the predetermined point of the support rod and the lower end of the support rod is curved to have a larger radius.

### TECHNICAL FIELD

The present invention relates to a crutch, which is a supporting staff for assisting a lame or infirm person in walking, and more particularly to a crutch, which is serviceable and stable in use, without placing pressure on the tissues, muscles and nerves of the user's armpit.

### BACKGROUND ART

FIG. 1 is a perspective view of a conventional crutch, and FIG. 2 is a side elevation view of the conventional crutch in use. As shown in the drawing, a conventional crutch 1, which is implemental equipment to assist a person having an inconvenient lower body in walking, comprises a cross-pad 3 adapted to be fitted in a user's armpit, a support rod 2, which is branched in its upper part and connected to the cross-pad 3 at its upper branched ends, a hand piece 4 fixed between the branched portions of the support rod 2, and a cap 5 for preventing the crutch from skidding mounted on a lower end of the support rod 2 to prevent the lower end of the support rod 2 from slipping. In use of the crutch 1, a user interposes the cross-pad 3 in his/her armpit, and grasps the hand piece 4 by his/her hand to support his/her body weight with the support rod 1. Generally, the crutch 1 is inclined with respect to a user's body when the crutch 1 supports the user's body on the ground, so as to give a stable supporting capability to the user and less pressure on the tissues, muscles and nerves of the user's armpit.

Accordingly, a length of the crutch must be changed according to a user's body length. Where the crutch 1 is excessively long, compared to a user's body, it is difficult for the user to support his/her body weight with the crutch 1 because of an excessively large angle between the crutch 1 and the user's body. On the other hand, where the crutch 1 is excessively short, compared to a user's body, it is difficult for the user to keep a right posture as well as to support his/her body because of an approximately parallel configuration defined between the crutch 1 and the user's body. Therefore, the crutch 1 is commonly constructed to be higher than a height of a user's armpit.

However, since such a conventional crutch 1 is designed to support a user's body weight by its cross-pad 3 and hand piece 4, after use over an extended period, the user suffers from an intensive pressure on nerves of his/her armpit and a paralysis of his/her armpit. In addition to this, the user suffers from a blister on his/her palm grasping the hand piece 4.

In use, since a length of the crutch 1 is generally longer than a height of a user's armpit, the user conducts a walking motion while moving the crutch along a semi-circular path laterally spaced from the user, thereby requiring a wide area around the user. Accordingly, since the crutch 1 interferes with surrounding passersby, who are walking around a user, both the user and the surrounding passersby suffer from inconvenience. Furthermore, when a user ascends passages such as a stairway and a hill while interposing the crutch 1 in his/her armpit, since an angle defined between the crutch 1 and the user's body become large, the crutch 1 cannot support the user's body weight, thereby the crutch 1 cannot carry out its objective function.

In addition, since the conventional crutch 1 is used in a state of being inclined, the cap 5, which is fitted on a lower end of the crutch 1, comes into contact with the ground surface at only its partial portion. Therefore, the cap 5 cannot sufficiently carry out a function of preventing slippage on the ground surface. In this connection, since only the partial portion of the cap 5 comes into contact with the ground surface, the portion of the cap 5 is early worn away, compared to the remaining portion of the cap 5. As force acting vertically on the above mentioned inclined crutch 1, the crutch 1 get bent after use over an extended period.

To overcome the above-mentioned problems occurring in the prior art, although crutches, which are designed to be controlled in its length according to a user's body size, are developed these days, the crutches have disadvantages such as complex structures, high manufacturing costs and instability.

### DISCLOSURE OF THE INVENTION

Accordingly, the present invention has been made keeping in mind the above problems occurring in the prior art, and an object of the present invention is to provide a crutch, which does not give pressure on the tissues, muscles and nerves of the user's armpit and damage to the user's palm.

Another object of the present invention is to provide a crutch, which is designed to eliminate discomfort in walking as well as interference with surrounding passersby.

A further object of the present invention is to provide a crutch, which is provided with a cap for preventing the crutch from skidding adapted to come into contact with the ground at its whole bottom surface, to afford stability of the crutch and prevention of the cap's abrasion

In order to accomplish the above object, the present invention provides a crutch including a support rod, a lower part between a lower end and a predetermined point below a mid point of the support rod is bent to a large radius and an upper part between the predetermined point and an upper end of the support rod is bent to a smaller radius; a cross-pad mounted on the upper end of the support rod; a hand piece positioned at the mid point of the support rod; and a cap for preventing the crutch from skidding mounted on a lower end of the support rod.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a conventional crutch;

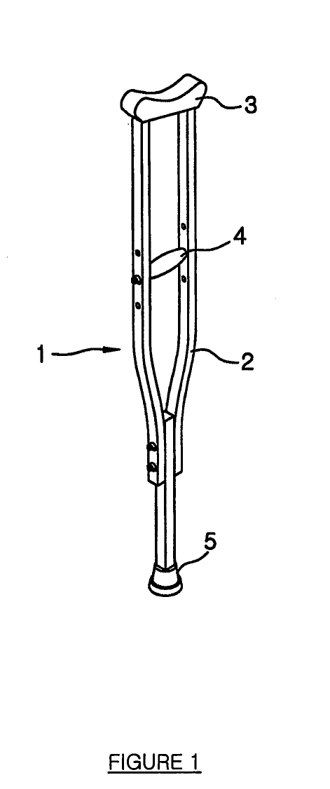

FIG. 2 is an illustration of the conventional crutch of FIG. 1, in use;

FIG. 3 is a perspective view of a crutch according to an embodiment of the present invention;

FIG. 4 is an illustration of the crutch according to an embodiment of the present in use; and

FIG. 5 is a schematic view showing the decomposition of a force applied to the conventional crutch of FIG. 1 and the crutch according to the present invention of FIG. 3.

### BEST MODE FOR CARRYING OUT THE INVENTION

Reference should now be made to the drawings, in which the same reference numerals are used throughout the different drawings to designate the same or similar components.

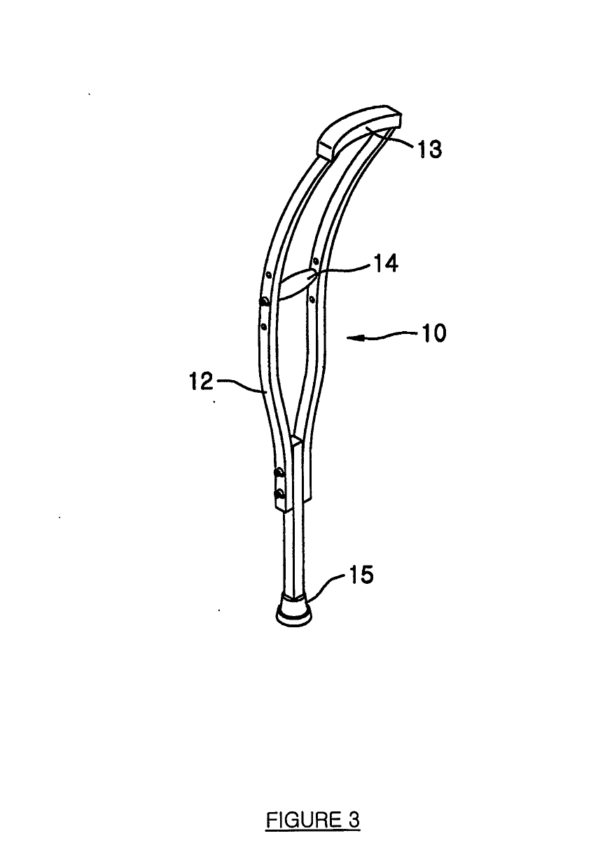

FIG. 3 is a perspective view of a crutch according to an embodiment of the present invention. As shown in the drawing, the crutch 10 according to the present invention comprises a cross-pad 13 made of appropriate material such as wood and aluminum and adapted to support a user's armpit, as in a conventional crutch, a support rod 12, which is connected to the cross-pad 13 at its upper branched ends and extended downward to have a length suitable for a user's body size, a hand piece 14 fixed to a predetermined position of the support rod 12, and a cap 15 for preventing the crutch from skidding mounted on a lower end of the support rod 12 to prevent the lower end of the support rod 12 from slipping.

The support rod 12 is gently bent to have a bow shape, in which an upper part corresponding to a section between the cross-pad 13 and the diverging point of the support rod 12 below the hand piece 14 is bent to have a smaller curvature radius, while a lower part corresponding to a section between the diverging point and the lower end of the support rod 12 is bent to have a larger curvature radius, that is, a virtually straight shape.

Functions of the crutch according to the present invention will now be described.

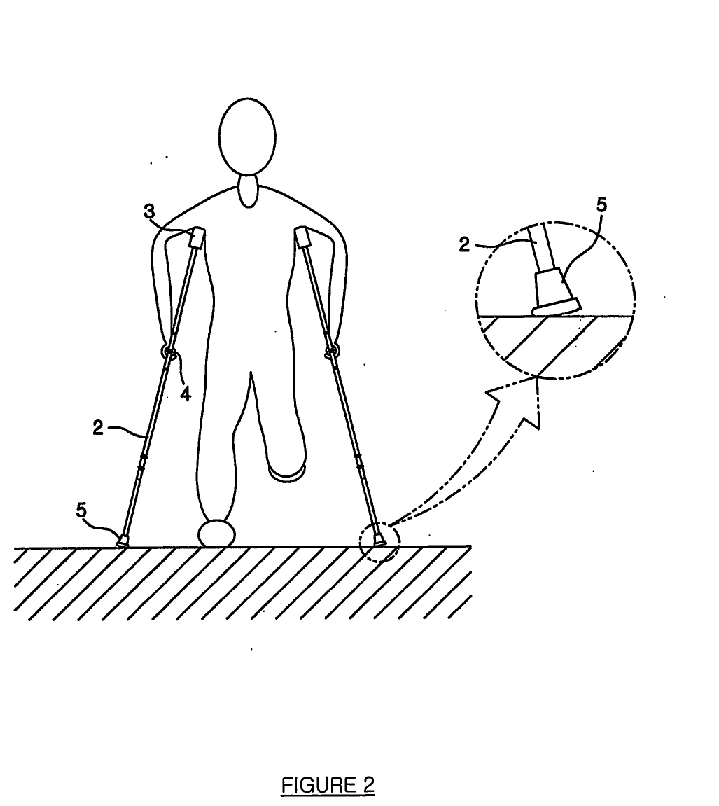

As shown in FIG. 2, since the conventional crutch 1 is in contact with the ground surface in a state of being inclined by a relatively large angle with respect to a user's body, a user carries out a walking motion while pushing the hand piece 3 downwardly by his/her hand to support his/her body weight with the crutch 1.

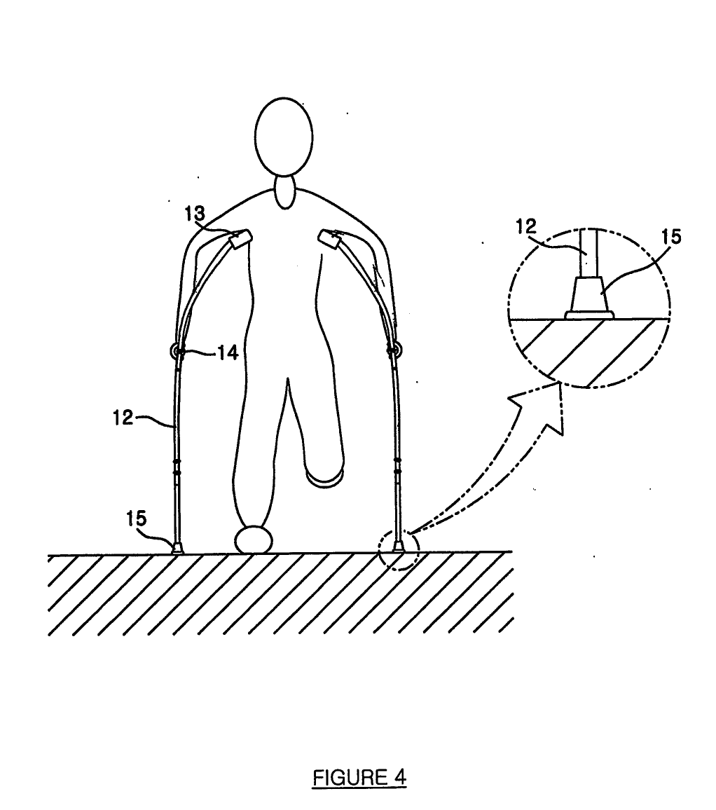

Meanwhile, from FIG. 4, it is appreciated that the crutch 10 according to the present invention has the support rod 12, which is slightly bent at its upper part and then is almost vertically extended at its lower part. That is, the upper part of the support 12 is bent by a relatively large extent while the lower part is nearly straightly extended, to allow the cross-pad 13 to be positioned beneath a user's armpit.

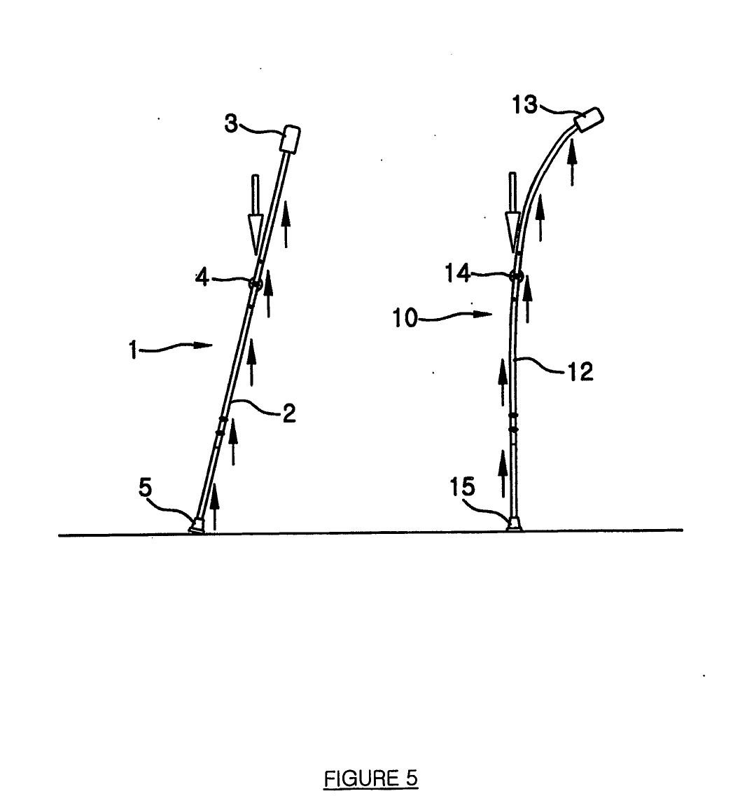

Accordingly as shown in FIG. 5, in the conventional crutch 1 in a state of supporting a user, since an extending direction of the support rod 2 is considerably different from a direction of force acting on the hand piece 4 by user's hand, a force, which is vertically applied to the hand piece 4 of the crutch 1, is decomposed into a first component force F1, which is horizontally directed toward the user's armpit, and a second component force F2, which is directed downward along the crutch 1. Of the first and second component forces F1 and F2, the first horizontal component force F1 is applied to the user's armpit, thereby forcibly pressing on the user's armpit.

In contrast with the conventional crutch 1, in the crutch 10 according to the present invention, since the lower part of the support rod 12 is positioned on the ground to be vertically erected, a force, which is vertically applied to the hand piece 14 of the crutch 10, is wholly transmitted to the cap 15 for preventing the crutch from skidding, without creation of a horizontal force directing toward the user's armpit, thereby alleviating discomfort in the user's armpit. Furthermore, since excessive bending load is not applied to the crutch 10, there is no distortion such as a flexure of the crutch 10.

In addition, since the upper part of the support rod 10 is gently bent inwardly, so as to allow the lower part of the support rod 10 to be positioned near to the user, compared to the convention crutch 1, the user can carry out the walking motion while moving the crutch 10 along a semi-circular path having a relatively short radius. Therefore, by the reduced waling range occupied by the user and the crutch 10, the crutch 10 almost does not give interference to surrounding passersby.

In use, since the lower part of the support rod 12 is positioned to be perpendicular to the ground, the cap 15 for preventing the crutch from skidding mounted on the lower end of the support rod 12 is in contact with the ground at its whole bottom area. Accordingly, the cap 15 for preventing the crutch from skidding of the crutch 10, according to the present invention, is less worn, compared to the cap 5 of the conventional crutch 1, which is in limited contact with the ground only at its local bottom area, thus stabilizing a user's walking posture and reducing the abrasion of the cap 15 for preventing the crutch from skidding.

### INDUSTRIAL APPLICABILITY

As described above, the present invention provides a crutch having advantages as follows.

Since a user's body weight is evenly distributed throughout the crutch, pressure and thus discomfort to a user's armpit is alleviated, and damage to a user's palm is also reduced. Therefore, there is no flexure in the crutch, even after use over an extended period of time.

Since the crutch does not have a large walking path due to its bent configuration, unlike a conventional crutch, the user can walk conveniently, with reduction of interference with surrounding passersby.

Since the lower part of the support rod is almost vertically erected on the ground, the cap for preventing the crutch from skidding mounted on the lower end of the support rod is in contact with the ground at its whole bottom area. Therefore, the crutch according to the present invention enables a user to stably walk, and enables the cap for preventing the crutch from skidding to be less worn away.

As such, the crutch according to the present invention provides a user with considerable stabilization and convenience, compared to the conventional crutch.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A crutch comprising a curved support rod, a cross-pad mounted on the upper end of the curved support rod, a hand piece positioned at the mid point of the curved support rod; and a cap for preventing the crutch from skidding mounted on a lower end of the curved support rod characterized in that;
the lowest part of the curved support rod is nearly straightly extended; and
the closer to the upper part of the support rod, the more curved with a smaller radius the support rod is.
